(19) United States
(12) Patent Application Publication
(10) Pub. No.: US 2003/0073795 A1
(43) Pub. Date: Apr. 17, 2003

(54) Pellicle film for lithography

(75) Inventors: Takayuki Araki, Osaka (JP); Meiten Koh, Osaka (JP); Mihoko Ohashi, Osaka (JP)

Correspondence Address: SUGHRUE MION, PLLC, 2100 PENNSYLVANIA AVENUE, N.W., WASHINGTON, DC, 20037, US

(73) Assignee: DAIKIN INDUSTRIES, LTD.

(21) Appl. No.: 10/214,132

(22) Filed: Aug. 8, 2002

(30) Foreign Application Priority Data
Aug. 10, 2001 (JP) 2001-244103

(51) Int. Cl. C08F 12/20

(52) U.S. Cl. 526/242

(57) ABSTRACT

There is obtained a pellicle film for lithography which is excellent in transparency in vacuum ultraviolet light, particularly in F₂ laser light (157 nm), and lowering of transmittance due to photo-degrading and a decrease in a film thickness are inhibited. Thereby excellent laser exposure resistance and transparency can be maintained for a long period of time and a clear pattern can be produced. The pellicle film for lithography comprises a solvent-soluble fluorine-containing polymer (A) and the polymer is non-crystalline and is composed of a chain structure having no ring structure on its trunk chain and an absorption coefficient at 157 nm of the polymer (A) is not more than 0.5 μm⁻¹.

### BACKGROUND OF THE INVENTION

The present invention relates to a pellicle film for lithography, particularly a pellicle film for lithography which has an excellent transmittance of ultraviolet light having a wavelength of less than 200 nm and vacuum ultraviolet light (ArF (193 nm) and F₂ excimer laser (157 nm)) and exhibits a high resolution.

In a photolithography process which is one of production processes of semiconductor devices such as LSI and VLSI or liquid crystal panels, there is a step for transferring, by exposure of light, a circuit drawn on a photomask or reticle (those are collectively called a mask) to a semiconductor wafer or a substrate for a liquid crystal panel which is coated with a resist. In that step, if a foreign matter is attached on the mask, there arise a deformation of a transferred pattern, line edge roughness, etc. due to an absorption and reflection of light attributable to the foreign matter, which causes a problem with lowering of product quality and yield.

Thus a foreign matter on the substrate to be exposed causes a big problem. However since it is difficult to always keep the substrate clean, a method of adhering a pellicle film on the substrate is usually employed. According to that method, a foreign matter is attached on the pellicle film adhered to the substrate, and therefore, when a focus is placed on a pattern of the substrate at a lithography step, the foreign matter on the pellicle film becomes out of focus, and there is no influence on the transferred pattern.

As mentioned above, since the pellicle film is adhered on the substrate, its transmittance of light must be good. Therefore, resins which have been reported as a resin for the pellicle film are nitrocellulose, cellulose acetate and fluorine-containing alicyclic perfluoro resin which are transparent at wavelengths of laser light (I-beam, g-beam, KrF, ArF) having been used for lithography (JP-A-9-160222, JP-A-11-209685, JP-A-3-67262). Particularly in case of lithography using a KrF excimer laser (248 nm) or ArF excimer laser (193 nm), a so-called non-crystalline fluorine-containing alicyclic perfluoro resin having a ring structure on its trunk chain is considered to have a high transparency and therefore has been used practically.

Recently in semiconductor processes, shortening of a wavelength of exposure light has been advanced for enhancement of integration degree as a result of microfabrication of a pattern, and a F₂ excimer laser (wavelength: 157 nm) is considered most promising as a next-coming light source. Therefore, it is of urgent necessity to develop a pellicle film for the F₂ excimer laser.

The above-mentioned fluorine-containing alicyclic perfluoro resin having a ring structure on its trunk chain has a sufficient transparency for a KrF laser and ArF laser and can be used for a pellicle film. However its transparency for a F₂ laser is insufficient, and even if it has a sufficient transparency, particularly its durability (laser-exposure resistance) is inferior and there is a problem that coloring arises and transparency is lowered by continuous irradiation of a F₂ laser.

From the viewpoint of transparency, a fluorine-containing polymer is preferred as a material for pellicle film. Therefore examples of using, as a pellicle film, films of fluorine-containing resins such as PFA, FEP and PVdF other than the above-mentioned fluorine-containing alicyclic perfluoro resin have been reported (JP-A-1-241557). However since any of those resins are crystalline polymers, transmitting light is scattered on crystalline portions of the pellicle film, which lowers transparency of the film. Also with respect to those films, there is no report on application of a F₂ laser to a pellicle film.

Also there is a report in which perfluorinated ion exchange polymers having a functional group -SO₃M are used for a pellicle film (JP-A-2-272551). However transparency of those polymers is insufficient due to an absorption by -SO₃M, and particularly transparency thereof in a vacuum ultraviolet region at a wavelength of less than 200 nm, for example, at 157 nm is insufficient. Further those polymers are not preferred from the viewpoint of crystallinity thereof like the above-mentioned polymers.

JP-A-3-190936 discloses that fluorine-containing resins comprising a fluoroolefin, a vinyl monomer selected from a non-fluorine-containing vinyl ether, vinyl ester and a-olefin and a nonionic monomer are used for a pellicle film. However since those resins have fluorine atoms only in the fluoroolefin unit, a fluorine content is low and transparency is inferior. Particularly there is a problem that transparency in a vacuum ultraviolet region at a wavelength of less than 200 nm is low. Further laser-exposure resistance in a vacuum ultraviolet region is insufficient, and by irradiation of vacuum ultraviolet light, there arise lowering of mechanical properties, a decrease in a film thickness, lowering of transparency and coloration.

Further a point to be noted is that in any of the above-mentioned publications and reports, there is neither description nor suggestion as to application of a F₂ laser to a pellicle film.

As mentioned above, there have been no attempts to apply fluorine-containing polymers which are non-crystalline, are transparent in a vacuum ultraviolet region and do not have a ring structure on a trunk chain thereof to a pellicle film, and particularly no attempts of applying a F₂ laser to a pellicle film have been made.

Namely, an object of the present invention is to put a non-crystalline fluorine-containing polymer having a high transparency for light having a wavelength of less than 200 nm to practical use as a pellicle film which is subjected to irradiation of light having such a wavelength. Particularly an object of the present invention is to provide a pellicle film of a non-crystalline fluorine-containing polymer which has a higher transparency for F₂ laser light (157 nm) and is practically used for lithography using a F₂ laser.

### SUMMARY OF THE INVENTION

The inventors of the present invention have made intensive studies to achieve the above-mentioned objects, and as a result, have found that a specific fluorine-containing polymer not having a ring structure on its trunk chain, namely a specific fluorine-containing polymer being composed of a chain structure on its trunk chain has a high transparency for light having a wavelength of less than 200 nm (ArF and F₂ laser light), particularly for F₂ laser light (157 nm) and thus has a sufficient practicability (durability) in irradiation of F₂ laser light (157 nm).

Namely, the present invention relates to a pellicle film for lithography which comprises a solvent-soluble fluorine-containing polymer (A), in which the polymer (A) is non-crystalline and is composed of a chain structure having no ring structure on its trunk chain and an absorption coefficient at 157 nm of the polymer (A) is not more than 0.5 μm⁻¹.

The fluorine-containing polymer (A) in the present invention is a non-crystalline polymer. When this non-crystalline polymer is heated from 20° C. to 300° C. at a heating rate of 10° C./min, for example, by a differential scanning calorimetric method (DSC), heat of fusion thereof is less than 1 J/g. Since the polymer is non-crystalline, scattering and absorption of light which arise at crystal portions are inhibited, which is advantageous from the viewpoint of transparency.

Particularly when the non-crystalline fluorine-containing polymer having no ring structure on its trunk chain is used, a pellicle film excellent in transparency and durability can be obtained.

Also since a molecular absorption coefficient of the polymer at a wavelength of 157 nm is not more than 0.5 μm⁻¹ the polymer is preferred because it can be used for exposure process using a F₂ laser. It is particularly preferable that a molecular absorption coefficient at a wavelength of 157 nm is not more than 0.3 μm⁻¹, and thereby the polymer can be preferably used as a pellicle film for a F₂ laser.

The fluorine-containing polymer (A) which is preferably used as a pellicle film of the present invention for lithography is characterized by having no ring structure on its trunk chain. Concretely it is preferable that the polymer has a Rf group having fluorine atom on its side chain from the viewpoint of transparency, maintenance of non-crystallinity and durability.

The Rf group on the side chain of the fluorine-containing polymer (A) used in the present invention is selected from a fluoroalkyl group of a linear or branched chain of C4 to C 100 in which at least a part of hydrogen atoms is replaced with fluorine atoms and/or an ether-bond-containing fluoroalkyl group of a linear or branched chain of C4 to C100 in which at least a part of hydrogen atoms is replaced with fluorine atoms. The polymer may have one Rf group or two or more Rf groups.

It is preferable that the Rf group has a high fluorine content. It is particularly preferable that the Rf group is at least one selected from a perfluoroalkyl group of a linear or branched chain of C4 to C100 and/or an ether-bond-containing perfluoroalkyl group of a linear or branched chain of C4 to C100.

When the number of carbon atoms of the Rf group is too small, it is not preferable because the fluorine content is not sufficient and crystal portions are easily generated, thereby lowering transparency. Also when the number of carbon atoms is too large, it is not preferable because solubility of the polymer in a solvent is lowered and mechanical properties of the polymer are lowered.

### DETAILED DESCRIPTION

Example of the preferred fluorine-containing polymer (A) which is used for a pellicle film of the present invention for lithography is a fluorine-containing polymer represented by the formula (1):

-(M)-(A)- (1)

in which the structural unit M is a structural unit represented by the formula (M1):

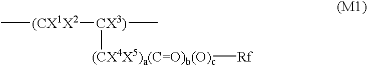

wherein X¹ and X² are the same or different and each is H or F; X³ is H, F, CH₃ or CF₃; X⁴ and X⁵ are the same or different and each is H, F or CF₃; a, b and c are the same or different and each is 0 or 1; when a is 0, Rf is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms; when a is 1, Rf is at least one selected from a fluoroalkyl group of a linear or branched chain of C3 to C99 in which at least a part of hydrogen atoms is replaced with fluorine atoms or an ether-bond-containing fluoroalkyl group of a linear or branched chain of C3 to C99 in which at least a part of hydrogen atoms is replaced with fluorine atoms,

the structural unit A is a structural unit derived from a monomer copolymerizable with the fluorine-containing ethylenic monomer giving the structural unit M represented by the formula (M1),

and the polymer comprises from 1 to 100% by mole of the structural unit M and from 0 to 99% by mole of the structural unit A.

The structural unit M in the fluorine-containing polymer of the formula (1) is a structural unit derived from a monomer having, on its side chain, a Rf group having fluorine atoms, and is selected from the above-mentioned structural unit (M1).

In the fluorine-containing polymer (A) used for the pellicle film of the present invention, the first example of the preferred structural unit M is a structural unit represented by the formula (M2):

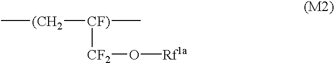

wherein Rf^{1a} is at least one selected from a fluoroalkyl group of a linear or branched chain of C3 to C99 in which at least a part of hydrogen atoms is replaced with fluorine atoms or an ether-bond-containing fluoroalkyl group of a linear or branched chain of C3 to C99 in which at least a part of hydrogen atoms is replaced with fluorine atoms.

The second example of the preferred structural unit M is a structural unit represented by the formula (M3):

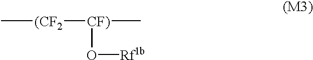

wherein Rf^{1b} is at least one selected from a fluoroalkyl group of a linear or branched chain of C4 to C100 in which at least a part of hydrogen atoms is replaced with fluorine atoms or an ether-bond-containing fluoroalkyl group of having a linear or branched chain of C4 to C100 in which at least a part of hydrogen atoms is replaced with fluorine atoms.

It is preferable from the viewpoint of transparency that Rf^{1a} and Rf^{1b} in the structural units M2 and M3, respectively are at least one selected from a perfluoroalkyl group of a linear or branched chain or an ether-bond-containing perfluoroalkyl group having a linear or branched chain.

Examples of the monomer giving the above-mentioned structural unit M2 are, for instance, structural units derived from monomers represented by:

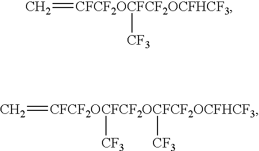

CH₂=CFCF₂OCH₂CF₂CF₂OCFHCF₃,

CH₂=CFCF₂OCH₂CF₂CF₂OCH₂CF₂CF₂OCFHCF₃,

CH₂=CFCF₂OCH₂CF₂CF₂OCH₂CF₂H,

CH₂=CFCF₂OCH₂CF₂CF₂OCH₂CF₂CF₂OCH₂CF₂H,

CH₂=CFCF₂OC₄F₉,

CH₂=CFCF₂OC₄F₈H,

CH₂=CFCF₂OCH₂C₄F₈H,

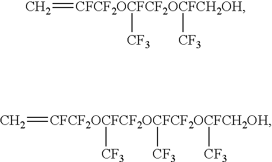

Those exemplified monomers are preferred because homo-polymerizability thereof or copolymerizability with each other is high and many fluorine atoms can be introduced to the polymer. Also those monomers are preferred because a non-crystalline polymer can be obtained depending on the homo-polymerization (or copolymerization).

Further the monomers exemplified above are preferred because copolymerizability thereof with other fluorine-containing ethylenic monomer is high and physical properties and solubility in a solvent of the polymer can be controlled while maintaining a high fluorine content.

Examples of the monomer giving the above-mentioned structural unit M3 are, for instance, structural units derived from monomers represented by:

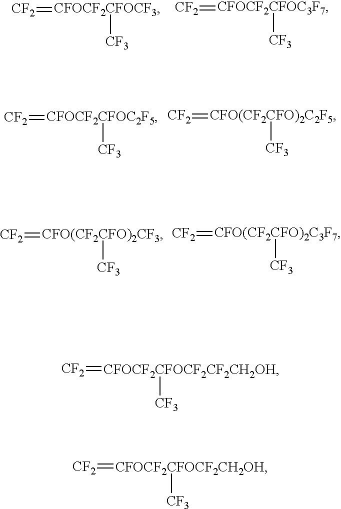

CF₂=CFOCH₂C₄F₈H, CF₂=CFOCH₂C₆F₁₂H,

CF₂=CFOCH₂CH₂C₄F₉, CF₂=CFOCH₂CH₂C₈F₁₇ and

CF₂=CFO(CF₂CF₂CF₂O)₂OC₃F₇.

The monomers exemplified above are preferred because copolymerizability thereof with other fluorine-containing ethylenic monomer is high and physical properties and solubility in a solvent of the polymer can be controlled while maintaining a high fluorine content.

The third example of the preferred structural unit M is a structural unit represented by the formula (M4):

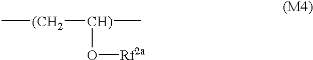

wherein Rf^{2a} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

The fourth example of the preferred structural unit M is a structural unit represented by the formula (M5):

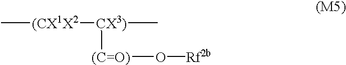

wherein X¹ and X² are the same or different and each is H or F; X³ is H, F, CH₃ or CF₃; Rf^{2b} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

From the point that transparency can be enhanced, particularly preferred is a structural unit represented by the formula (M6):

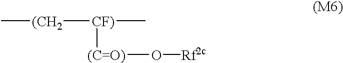

wherein Rf^{2c} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

It is preferable that Rf^{2a}, Rf^{2b} and Rf^{2c} in those formulae (M4), (M5) and (M6), respectively are:

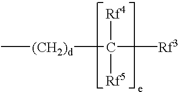

wherein Rf³ is at least one selected from a fluoroalkyl group of a linear or branched chain in which at least a part of hydrogen atoms is replaced with fluorine atoms or an ether-bond-containing fluoroalkyl group of a linear or branched chain in which at least a part of hydrogen atoms is replaced with fluorine atoms; Rf⁴ and Rf⁶ are the same or different and each is at least one selected from hydrogen atom, a perfluoroalkyl group having 1 to 5 carbon atoms or a hydrocarbon group having 1 to 10 carbon atoms; a sum of carbon atoms of Rf^{3,} Rf and Rf⁵ is from 4 to 100; d is 0 or 1; e is 0 or an integer of 1 or 2; provided that d is 0, e is 1 or 2, in which it is particularly preferable from the viewpoint of transparency that Rf³ is at least one selected from a perfluoroalkyl group of a linear or branched chain or an ether-bond-containing perfluoroalkyl group of a linear or branched chain.

Examples of the preferred monomer giving the structural unit M4 are, for instance,

CH₂=CHOCH₂C₄F₈H, CH₂=CHOCH₂C₆F₁₂H,

CH₂=CHOCH₂CH₂C₄F₉, CH₂=CHOCH₂CH₂C₈F₁₇,

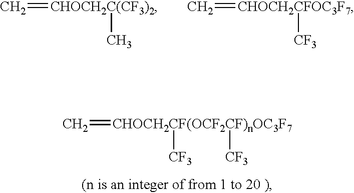

CH₂=CHOCH₂CF₂CF₂OC₃F₇ and

CH₂=CHOCH₂CF₂CF₂(OCF₂CF₂CF₂)ₙOC₃F₇

(n is an integer of from 1 to 20).

The monomers exemplified above are preferred because copolymerizability thereof with other fluorine-containing ethylenic monomer is high and physical properties and solubility in a solvent of the polymer can be controlled while maintaining a high fluorine content.

Examples of the monomer giving the above-mentioned structural units M5 and M6 are, for instance, structural units derived from monomers represented by:

CH₂=CHCOOCH₂C₄F₈H, CH₂=CHCOOCH₂C₆F₁₂H,

CH₂=CHCOOCH₂CH₂C₄F₉, CH₂=CHCOOCH₂CH₂C₈F₁₇,

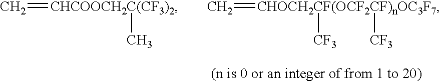

CH₂=CHOCH₂CF₂CF₂(OCF₂CF₂CF₂)ₙOC₃F₇

(n is 0 or an integer of from 1 to 20),

CH₂=C(CH₃)COOCH₂C₄F₈H,

CH₂=C(CH₃)COOCH₂C₆F₁₂H,

CH₂=C(CH₃)COOCH₂CH₂C₄F₉,

CH₂=C(CH₃)COOCH₂CH₂C₈F₁₇,

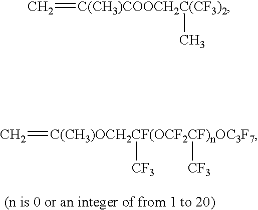

CH₂=C(CH₃)OCH₂CF₂CF₂(OCF₂CF₂CF₂)ₙOC₃F₇

(n is 0 or an integer of from 1 to 20),

CH₂=CFOCH₂C₄F₈H, CH₂=CFOCH₂C₆F₁₂H,

CH₂=CFOCH₂CH₂C₄F₉, CH₂=CFOCH₂CH₂C₈F₁₇,

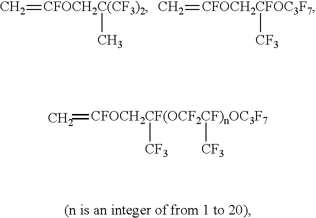

CH₂=CFOCH₂CF₂CF₂OC₃F₇,

CH₂=CFOCH₂CF₂CF₂(OCF₂CF₂CF₂)ₙOC₃F₇

(n is an integer of from 1 to 20),

CH₂=C(CF₃)COOCH₂C₄F₈H, CH₂=C(CF₃)COOCH₂C₆F₁₂H,

CH₂=C(CF₃)COOCH₂CH₂C₄F₉, CH₂=C(CF₃)COOCH₂CH₂C₈F₁₇,

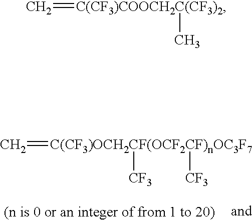

CH₂=C(CF₃)OCH₂CF₂CF₂(OCF₂CF₂CF₂)ₙOC₃F₇

(n is 0 or an integer of from 1 to 20).

Those exemplified monomers are preferred because homo-polymerizability thereof or copolymerizability with each other is high and many fluorine atoms can be introduced to the polymer. Also those monomers are preferred because a non-crystalline polymer can be obtained depending on the homo-polymerization (or copolymerization).

Further the monomers exemplified above are preferred because copolymerizability thereof with acrylic monomers other than those exemplified above is high and physical properties and solubility in a solvent of the polymer can be controlled while maintaining a high fluorine content.

The structural unit A in the fluorine-containing polymer of the formula (1) of the present invention is an optional component, and is not limited particularly as far as it is copolymerizable with the structural unit M (M1, M2, M3, M4, M5 or M6). The structural unit A may be selected optionally as case demands. The structural unit A does not always comprise one monomer, and optional monomers copolymerizable with the structural unit M (M1, M2, M3, M4, M5 or M6) may be contained in an optional ratio.

Examples of the monomer giving the structural unit A are, for instance, as follows.

\mathring{1} Fluorine-containing ethylenic monomers

Those monomers become a unit forming a trunk chain at polymerizing, and the monomers having halogen atom or CF₃ unit are preferred from the viewpoint of having a function of decreasing absorption by the trunk chain. Also from the viewpoint of contributing to enhancement of a strength of a pellicle film, ethylene a part of which is replaced with CF₃ or CH₃ is preferred because CF₃ and CH₃ have a function of increasing a steric hindrance of the trunk chain and elevating Tg of a produced polymer and also ethylene a part of which is replaced with halogen is preferred because halogen has a function of enhancing polarization of the trunk chain and elevating Tg of a produced polymer.

Examples thereof are:

CF₂=CF₂, CF₂=CFH, CF₂=CH₂, CF₂=CFCl,

CF₂=CCl₂, CH₂=C(CF₃)₂, CF₂=CFCF₃ and the like.

\mathring{2} Fluorine-containing ethylenic monomers having functional group

To the fluorine-containing polymer (A) can be introduced a functional group in a range not lowering transparency. The introduction of a functional group is preferred because by an effect of the functional group, solubility in a solvent and film forming property can be improved and a film strength can be increased. In that case, particularly a polymer obtained by copolymerizing a fluorine-containing ethylenic monomer having functional group is preferred from the viewpoint of transparency.

Example of the preferred structural unit derived from a fluorine-containing ethylenic monomer having functional group is a structural unit represented by the formula (2):

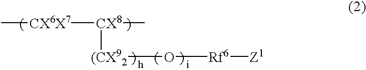

wherein X⁶, X⁷ and X⁸ are H or F; X⁹ is H, F or CF₃; h is from 0 to 2; i is 0 or 1; Rf⁶ is a fluorine-containing alkylene group having 1 to 40 carbon atoms or a fluorine-containing alkylene group having 2 to 100 carbon atoms and ether bond; Z¹ is at least one selected from OH, CH₂OH, COOH, carboxylic acid derivative, SO₃H, sulfonic acid derivative, epoxy group and cyano group. Particularly preferred are structural units derived from:

CH₂=CFCF₂ORf⁶-Z¹

wherein Rf⁶ and Z¹ are as defined above.

Concretely there are preferably structural units derived from fluorine-containing ethylenic monomers such as:

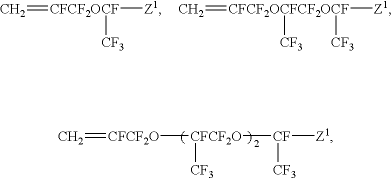

CH₂=CFCF₂OCH₂CF₂'Z¹,

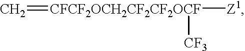

CH₂=CFCF₂OCF₂CF₂OCF₂-Z¹ and

CH₂=CFCF₂O(CF₂CF₂O)CF₂-Z¹,

wherein Z¹ is as defined above.

Also there are preferably structural units derived from:

CF₂=CFORf⁶-Z¹

wherein Rf⁶ and Z¹ are as defined above.

Concretely there are preferably structural units derived from monomers such as:

CF₂=CFOCF₂CF₂-Z¹, CF₂=CFOCF₂CF₂CH₂-Z¹,

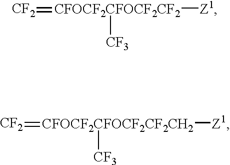

CF₂=CFO(CF₂)₃Z¹, CF₂=CFO(CF₂)₃CH₂-Z¹,

CF₂=CFOCF₂CF₂OCF₂-Z¹, CF₂=CFOCF₂CF₂ CF₂CH₂-Z¹,

CF₂=CFOCF₂CF₂CH₂OCF₂CF₂-Z¹ and

CF₂=CFOCF₂CF₂CH₂OCF₂CF₂CH₂-Z¹,

wherein Z¹ is as defined above.

Other examples of the fluorine-containing ethylenic monomer having functional group are:

CF₂=CFCF₂-O-Rf-Z¹, CF₂=CF-Rf-Z¹,

CH₂=CH-Rf-Z¹, CH ₂=CHO-Rf-Z¹

and the like, wherein Rf is the same as Rf of the formula (1), Z¹ is the same as Z¹ of the formula (2). Examples thereof are:

CF₂=CFCF₂OCF₂CF₂CF₂-Z¹, CF₂=CFCF₂OCF₂CF₂CF₂CH₂-Z¹,

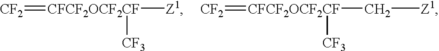

CF₂=CFCF₂-Z , CF₂=CFCF₂CH₂-Z¹,

CH₂=CHCF₂CF₂CH₂CH₂-Z¹, CH₂=CHCF₂CF₂-Z¹,

CH₂=CHCF₂CF₂CH₂-Z , CH₂=CHCF₂CF₂CF₂CF₂-Z¹,

CH₂=CHCF₂CF₂CF₂CF₂CH₂-Z¹, CH₂=CHO—CH₂CF₂CF₂-Z¹,

CH₂=CHOCH₂CF₂CF₂CH₂-Z¹

and the like, wherein Z¹ is as defined above.

The introduction of the structural units derived from those monomers is preferred since a solubility in a solvent, particularly in a general-purpose solvent can be imparted to the fluorine-containing polymer (A) while maintaining transparency of the polymer. Also a film forming property can be improved. In addition, the introduction of the structural units is preferred from the point that functions such as crosslinkability can be imparted to the polymer.

Among the above-mentioned monomers, those having the functional group Z¹ selected from OH, CH₂OH, cyano group and epoxy group are particularly preferred from the viewpoint of transparency. \mathring{3} Structural units derived from ethylenic monomers not having fluorine

The structural units derived from ethylenic monomers not having fluorine may be introduced in a range not so changing a refractive index (in a range not making a refractive index high). The introduction of those structural units is preferred from the viewpoint of improvement of compatibility with a general-purpose solvent, elevation of Tg and improvement of compatibility with a curing agent and photocatalyst to be added as case demands and from the viewpoint of introduction of a crosslinkable group.

Examples of the non-fluorine-containing ethylenic monomer are as follows.

α olefins:

Ethylene, propylene, butene, vinyl chloride, vinylidene chloride and the like.

Vinyl ether or vinyl ester monomers:

CH₂=CHOR, CH₂=CHOCOR and the like, wherein R is a hydrocarbon group having 1 to 20 carbon atoms.

Allyl monomers:

CH₂=CHCH₂Cl, CH₂=CHCH₂OH, CH₂=CHCH₂COOH, CH₂=CHCH₂Br and the like.

Allyl ether monomers:

CH₂=CHCH₂OR, wherein R is a hydrocarbon group having 1 to 20 carbon atoms,

CH₂=CHCH₂OCH₂CH₂COOH,

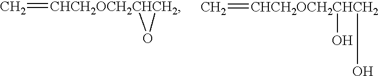

and the like.

Acrylic or methacrylic monomers:

Acrylic acid, methacrylic acid, acrylic acid esters, methacrylic acid esters, maleic anhydride, maleic acid, maleic acid esters and the like.

The pellicle film of the present invention is obtained, for example, by dissolving or dispersing the fluorine-containing polymer (A) comprising the above-mentioned components in a proper solvent and forming a film using the obtained solution. The solvent is not limited particularly as far as the fluorine-containing polymer (A) is dissolved or dispersed therein. Preferred is a solvent in which the fluorine-containing polymer (A) is dissolved uniformly.

Examples of the solvent are, for instance, cellosolve solvents such as methyl cellosolve, ethyl cellosolve, methyl cellosolve acetate and ethyl cellosolve acetate; ester solvents such as diethyl oxalate, ethyl pyruvate, ethyl-2-hydroxybutyrate, ethyl acetoacetate, butyl acetate, amyl acetate, ethyl butyrate, butyl butyrate, methyl lactate, ethyl lactate, methyl 3-methoxy propionate, ethyl 3-methoxy propionate, methyl 2-hydroxyisobutyrate and ethyl 2-hydroxyisobutyrate; propylene glycol solvents such as propylene glycol monomethyl ether, propylene glycol monoethyl ether, propylene glycol monobutyl ether, propylene glycol monomethyl ether acetate, propylene glycol monoethyl ether acetate, propylene glycol monobutyl ether acetate and dipropylene glycol dimethyl ether; ketone solvents such as 2-hexanone, cyclohexanone, methylaminoketone and 2-heptanone; alcohol solvents such as methanol, ethanol, propanol, isopropanol and butanol; and aromatic hydrocarbons such as toluene and xylene. Those solvents are used solely or in a mixture of two or more thereof.

Further in order to enhance solubility of the fluorine-containing polymer (A), a fluorine-containing solvent may be used, as case demands.

Examples of the fluorine-containing solvent are, for instance, CH₃CCl₂F (HCFC-141b), CF₃CF₂CHCl₂/CClF₂CF₂CHClF mixture (HCFC-225), perfluorohexane, perfluoro(2-butyltetrahydrofuran), methoxy-nonafluoro butane, 1,3-bistrifluoromethylbenzene, fluorine-containing alcohols such as:

H(CF₂CF₂)ₙCH₂OH (n: an integer of from 1 to 3),

F(CF₂)ₙCH₂OH (n: an integer of from 1 to 5) and

(CF₃)₂CHOH,

benzotrifluoride, perfluorobenzene, perfluoro(tributylamine), ClCF₂CFClCF₂CFCl₂ and the like.

Those fluorine-containing solvents may be used solely, in a mixture thereof or as a solvent mixture of non-fluorine-containing solvent and at least one fluorine-containing solvent.

Prior to making a solution, it is preferable to previously eliminate sparing amounts of metal component and colloid from the fluorine-containing polymer.

A concentration of the fluorine-containing polymer in the solution is generally in a range of from 1 to 30% by weight, particularly preferably from 2 to 20% by weight. If the concentration is too low, efficiency of forming a film and eliminating impurities is lowered, and if the concentration is too high, a viscosity is increased, thereby lowering workability of film formation and elimination of impurities.

The pellicle film of the present invention comprising the fluorine-containing polymer (A) can be formed by known method of film formation by flowing, for example, by a spin coating method, knife coating method or the like. Generally a thin film may be formed by flowing a polymer solution on a smooth surface of a substrate such as a glass plate. A thickness of the thin film can be adjusted or set by a viscosity of the solution and a rotation speed of the substrate.

The thin film formed on the substrate is dried with hot air, by irradiation of infrared ray, etc. and thus a remaining solvent can be eliminated.

A thickness of the pellicle film of the present invention varies depending on transparency of the fluorine-containing polymer (A) at a wavelength of exposure light to be used and mechanical properties of the fluorine-containing polymer (A). The thickness is generally selected in a range of from 0.05 to 10 μm. Namely, it is recommendable to set the thickness so that a transmittance of light at a wavelength of vacuum ultraviolet becomes high. For example, the thickness for a F₂ laser having a wavelength of 157 nm is preferably from 0.1 to 2.0 μm.

If the film thickness is too large, it is not preferable because transmittance becomes insufficient. On the contrary, if the film thickness is too small, a mechanical strength becomes insufficient and wrinkling easily occurs, which is not preferable from the viewpoint of handling.

The pellicle film of the present invention can be used as it is or by forming an inorganic or organic reflection inhibition film on one surface or both surfaces of the pellicle film.

A pellicle to be used for exposing can be manufactured by stretching and fitting a pellicle film on one side of a pellicle frame and applying an adhesive or adhering an adhesive tape on another side thereof for fitting the pellicle on a mask. The pellicle frame is not limited particularly, and those made of metals such as aluminum, aluminum alloy and stainless steel, synthetic resins or ceramics can be used. For stretching and fitting the pellicle film on the pellicle frame, an adhesive, for example, a silicone resin adhesive, a fluorine-containing resin adhesive or the like can be used.

The above-mentioned pellicle structure can prevent foreign matters from entering the inside of the pellicle from the outside, and even if foreign matters adhere on the pellicle film, they are transferred in a state being out of focus at exposing and therefore there hardly occurs a problem with line edge roughness.

Also in order to prevent generation of dusts inside the pellicle, a layer of known tacky substance can be formed on an inner surface of the pellicle film and on inner surfaces of the pellicle frame. Namely, forming the tacky layer on the inner surfaces of the pellicle frame and on the inner surface of the pellicle film is advantageous from the points that not only generation of dusts inside the pellicle film can be prevented but also floating dusts are stuck to the layer and can be prevented from adhering to a mask.

In an exposing step, a pellicle having a pellicle film manufactured by the above-mentioned method is fitted to a photomask or reticle of a glass substrate on which a circuit pattern is formed with a deposition of chrome, etc., and the circuit pattern is transferred on a silicon wafer having a coated resist thereon by using exposed ultraviolet light having a wavelength of less than 200 nm.

According to the present invention, even in case of using ultraviolet light, particularly vacuum ultraviolet light, transmittance is good and lowering of laser-exposure resistance attributable to photo-degrading of the pellicle film is small. As a result, a clear micro-fabricated pattern can be formed stably by lithography for a relatively long period of time.

Then the present invention is explained by means of examples and preparation examples, but is not limited to them.

### PREPARATION EXAMPLE 1

A 50 ml eggplant glass flask was charged with 3 g of perfluoro-(1, 1, 8-trihydro-5-trifluoromethyl-4,7-dioxanonene) (structural formula: CH₂=CFCF₂OCF(CF₃)CF₂OCFHCF₃ (monomer a)) and as an initiator, 1.33 g of 8.0% by weight of [H—(CF₂CF₂)₃—COO]₂— in perfluorohexane, and after the inside of the flask was sufficiently replaced with nitrogen gas, stirring was carried out at 20° C. for 24 hours in nitrogen gas stream. Thus a highly viscous solid was produced.

The obtained solid was subjected to re-precipitation with acetone as a good solvent and hexane as a bad solvent and then vacuum drying to obtain 2.17 g of a colorless transparent fluorine-containing polymer.

According to ¹⁹F-NMR and ¹H-NMR analyses, the polymer was a fluorine-containing polymer consisting of a structural unit of the above-mentioned fluorine-containing ally ether (a). A number average molecular weight and a weight average molecular weight measured according to GPC analysis using THF as a solvent were 28,000 and 53,000, respectively.

### PREPARATION EXAMPLE 2

A fluorine-containing polymer was synthesized in the same manner as in Preparation Example 1 except that perfluoro-(1,1,9,9-tetrahydro-2, 5-bistrifluoromethyl-3,6-dioxanonenol) (structural formula: CH₂=CFCF₂OCF(CF₃)CF₂OCF(CF₃)CH₂OH (monomer b)) was used as a fluorine-containing monomer.

The obtained solid was subjected to re-precipitation with acetone as a good solvent and benzene/hexane (volume ratio of 1:1) as a bad solvent and then vacuum drying to obtain 2.37 g of a colorless transparent solid.

According to ¹⁹F-NMR and ¹H-NMR analyses, the polymer was a fluorine-containing polymer consisting of a structural unit of the above-mentioned fluorine-containing ally ether (b). A number average molecular weight and a weight average molecular weight measured according to GPC analysis using THF as a solvent were 30,000 and 68,000, respectively.

### PREPARATION EXAMPLE 3

A fluorine-containing polymer was synthesized in the same manner as in Preparation Example 1 except that perfluoro-(1,1,5-trihydro-4-oxahexene) (structural formula: CH₂=CFCF₂OCFHCF₃ (monomer c)) was used as a fluorine-containing monomer.

According to ¹⁹F-NMR and ¹H-NMR analyses, the polymer was a fluorine-containing polymer consisting of a structural unit of the above-mentioned fluorine-containing ally ether (c). A number average molecular weight and a weight average molecular weight measured according to GPC analysis using THF as a solvent were 26,000 and 48,000, respectively.

### PREPARATION EXAMPLE 4

Synthesis was carried out in the same manner as in Preparation Example 1 except that a 100 ml eggplant flask was charged with 3 g of perfluoro-(1,1,9,9-tetrahydro-2,5-bistrifluoromethyl-3,6-dioxanonenol) (monomer b) and 2.84 g of perfluoro-(1,1,8-trihydro-5-trifluoromethyl-4, 7-dioxanonene) (monomer a) and 50 g of HCFC-225 was added as a solvent. After the reaction, re-precipitation with HCFC-225 as a good solvent and benzene/hexane (volume ratio of 1:1) as a bad solvent was carried out and then a precipitated product was dried.

According to ¹⁹F-NMR and ¹H-NMR analyses, the obtained polymer was a polymer comprising a fluorine-containing allyl ether (a) having —CF₃ group at its end and a fluorine-containing allyl ether (b) having —CH₂OH group at its end in a ratio of 42/58 in % by mole. A number average molecular weight and a weight average molecular weight measured according to GPC analysis using THF as a solvent were 24,000 and 38,000, respectively.

### PREPARATION EXAMPLE 5

A 100 ml stainless steel autoclave equipped with a valve, pressure gauge and thermometer was charged with 15.1 g of perfluoro-(1, 1,8-trihydro-5-trifluoromethyl-4,7-dioxanonene) (monomer a), 40 ml of HCFC-225 and 3.35 g of the same initiator as in Preparation Example 1, and was dipped in dry ice/acetone bath. After replacing the inside of the autoclave with nitrogen gas under vacuum repeatedly and eliminating oxygen in a system, the inside of the autoclave was evacuated and 4 g of tetrafluoroethylene was introduced, followed by shaking in a 22° C. water bath with a shaker for 20 hours to carry out a reaction. After completion of the reaction, the solvent was distilled off to obtain a solid. Then the obtained solid was subjected to re-precipitation with acetone as a good solvent and hexane as a bad solvent and a precipitated product was vacuum-dried to obtain a fluorine-containing polymer.

According to ¹⁹F-NMR and ¹H-NMR analyses, the obtained fluorine-containing polymer was a polymer comprising tetrafluoroethylene and a fluorine-containing allyl ether (a) having -CF₃ group at its end in a ratio of 25.5/74.5 in % by mole. A number average molecular weight and a weight average molecular weight measured according to GPC analysis using THF as a solvent were 17,700 and 29,500, respectively.

### PREPARATION EXAMPLE 6

A fluorine-containing polymer was synthesized in the same manner as in Preparation Example 5 except that perfluoro-(1,1,9,9-tetrahydro-2, 5-bistrifluoromethyl-3,6-dioxanonenol) (monomer b) was used as a fluorine-containing monomer in an amount of 16.32 g. After completion of the reaction, the solvent was distilled off to obtain a solid. Then the obtained solid was subjected to re-precipitation with acetone as a good solvent and benzene/hexane (volume ratio of 1:1) as a bad solvent and a precipitated product was dried to obtain a fluorine-containing polymer.

According to ¹⁹F-NMR and ¹H-NMR analyses, the obtained fluorine-containing polymer was a polymer comprising tetrafluoroethylene and a fluorine-containing allyl ether (b) having —OH group at its end in a ratio of 30.3/69.7 in % by mole. A number average molecular weight and a weight average molecular weight measured according to GPC analysis using THF as a solvent were 29,000 and 41,000, respectively.

### PREPARATION EXAMPLE 7

Synthesis was carried out in the same manner as in Preparation Example 6 except that 15.48 g of 5,5,6,6-tetrafluoro-3-oxahexene (structural formula: CH₂=CHOCH₂CF₂CF₂H (monomer d)), 8 g of tetrafluoroethylene and 6.69 g of the same initiator as in Preparation Example 1 were used to obtain 29.2 g of a solid fluorine-containing polymer.

According to ¹⁹F-NMR and ¹H-NMR analyses, the obtained polymer was a polymer comprising tetrafluoroethylene and a fluorine-containing vinyl ether (d) in a ratio of 51/49 in % by mole. A number average molecular weight and a weight average molecular weight measured according to GPC analysis using THF as a solvent were 98,000 and 178,000, respectively.

### PREPARATION EXAMPLE 8

Synthesis was carried out in the same manner as in Preparation Example 6 except that 7.04 g of 2-hydroxyethyl vinyl ether (monomer e), 8.0 g of tetrafluoroethylene and 6.69 g of the same initiator as in Preparation Example 7 were used to obtain 13.0 g of a colorless, transparent and solid fluorine-containing polymer.

According to ¹⁹F-NMR and ¹H-NMR analyses, the obtained polymer was a copolymer comprising tetrafluoroethylene and hydroxyethyl vinyl ether (e) in a ratio of 48/52 in % by mole. A number average molecular weight and a weight average molecular weight measured according to GPC analysis using THF as a solvent were 21,000 and 31,000, respectively.

### PREPARATION EXAMPLE 9

A 100 ml eggplant flask was charged with 20 g of αf-acrylate having a perfluoroalkyl group and ether bond on its side chain (structural formula: CH₂=CFCO—OCH₂CF₂CF₂(OCF₂CF₂CF₂)₂₀OCF₂CF₂CF₃ (monomer f)), 50 ml of HCFC-225 solution and 1.86 g of the same initiator as in Preparation Example 1. After replacing the inside of the autoclave with nitrogen gas under vacuum, stirring was carried out in nitrogen atmosphere for 24 hours. After the stirring, a solvent was condensed, followed by re-precipitating with hexane as a bad solvent and vacuum-drying of a precipitated product to obtain 17.6 g of a solid fluorine-containing polymer.

According to ¹⁹F-NMR and ¹H-NMR analyses, the obtained polymer was a fluorine-containing polymer consisting of the above-mentioned structural unit of αF-acrylate (f) having fluorine-containing ether on its side chain.

### PREPARATION EXAMPLE 10

Synthesis was carried out in the same manner as in Preparation Example 9 except that 10 g of hexafluoroisopropyl αF-acrylate (monomer g) as a monomer and 1.74 g of the same initiator as in Preparation Example 1 were used to obtain 8.9 g of a solid fluorine-containing polymer.

According to ¹⁹F-NMR and ¹H-NMR analyses, the obtained polymer was a fluorine-containing polymer consisting of the above-mentioned structural unit of αF-acrylate (g) having fluorine-containing ether on its side chain.

### PREPARATION EXAMPLE 11

A 200 ml glass flask equipped with a stirrer was charged with 6.7 g of perfluoro-(5,5-dihydro-allyl vinyl ether) (structural formula: CH₂=CFCF₂OCF=CF₂ (monomer h)), 160 g of HCFC-225 (a mixture of CF₃CF₂CHCl₂/CClF₂CF₂CHClF) and 6.9 g of 8.0% by weight of [H—(CF₂CF₂)₃-COO]₂- in perfluorohexane. After the inside of the flask was sufficiently replaced with nitrogen gas, stirring was carried out at 20° C. in nitrogen gas stream for 24 hours. After the solvent in the reaction mixture was distilled off with an evaporator and condensed, the reaction mixture was poured in hexane to precipitate a polymer. The polymer was separated and dried to obtain 5.2 g of a colorless transparent fluorine-containing polymer. Solubility of the obtained polymer in general-purpose solvents such as acetone, ethyl acetate, butyl acetate and THF was good.

According to IR analysis of the polymer, no absorption of double bond (in a range of from 1,400 to 1,700 Å) was recognized. According to ¹⁹F-NMR and ¹H-NMR analyses, the obtained polymer was a fluorine-containing polymer having, on its trunk chain, any of ring structures such as:

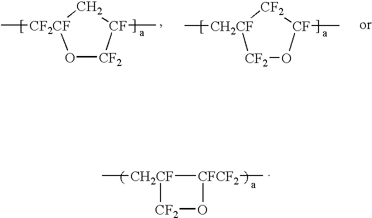

According to GPC analysis, a number average molecular weight thereof was 18,300.

### PREPARATION EXAMPLE 12

A 300 ml stainless steel autoclave equipped with a valve, pressure gauge and thermometer was charged with 15.9 g of bicyclo[2.2.1]hepto-2-ene (2-norbornene) (monomer i), 140 ml of HCFC-141b and 1.0 g of bis(4-tert-butylcyclohexyl)peroxydicarbonate (TCP). While cooling with dry ice/methanol solution, the inside of the system was sufficiently replaced with nitrogen gas. Then 30.0 g of tetrafluoroethylene was introduced through the valve, followed by shaking at 40° C. for 12 hours to carry out a reaction. With the advance of the reaction, a gauge pressure decreased from 1.0 MPaG before the reaction to 0.94 MPaG.

After releasing of an un-reacted monomer, a polymerization solution was removed and re-precipitated with methanol to separate a fluorine-containing polymer, followed by vacuum drying until a constant value was obtained. Thus 8.5 g of polymer was obtained.

According to ¹⁹F-NMR analysis, the fluorine-containing polymer was a copolymer comprising tetrafluoroethylene and fluorine-containing norbornene (i) in a ratio of 50/50 in % by mole. According to GPC analysis, a number average molecular weight thereof was 5,600.

Also DSC analysis was carried out with respect to the fluorine-containing polymers obtained in Preparation Examples 1 to 12, and any of them were identified as being non-crystalline.

### EXAMPLES 1 to 8 and COMPARATIVE EXAMPLES 1 to 4

(Measurement of absorption coefficient of fluorine-containing polymer)

(1) Preparation of coating composition

After dissolving each fluorine-containing polymer prepared in Preparation Examples 1 to 12 in butyl acetate so that its concentration became 3% by weight, the solution was filtrated through a 0.1 μm PTFE membrane filter to obtain a coating composition.

As a result, any of the polymers obtained in Preparation Examples 1 to 12 were identified as being able to be dissolved uniformly in butyl acetate.

(2) Coating

\mathring{1} Coating on a substrate (MgF₂) for measuring transparency Each coating composition was applied to a MgF₂ substrate with a spin coater at room temperature at 1000 revolutions. After the coating, baking was carried out at 100° C. for 15 minutes to produce a transparent coating film.

\mathring{2} Measurement of coating thickness

A coating film was produced using each coating composition under the same conditions as above except that a silicon wafer was used instead of the MgF₂ substrate. A coating thickness was measured with AFM device (SPI3800 available from Seiko Denshi Kabushiki Kaisha).

(3) Measurement of transparency in vacuum ultraviolet region

\mathring{1} Measuring device

Setani-Namioka type spectrometer (trade name BL-7B available from HIGH ENERGY KENKYU KIKO)

Slit: ⅞-⅞

Detector: PMT

Grating (GII: Blaze wavelength 160 nm, 1,200 gratings/mm)

For an optical system, refer to Rev. Sic. Instrum., 60(7), 1917 (1989) by H. Namba, et al.

\mathring{2} Measurement of transmitting spectrum

A transmitting spectrum at 300 to 100 nm of a coating film obtained by applying each coating composition on the MgF₂ substrate by the method of (2)\mathring{1} was measured using the above-mentioned device.

A molecular absorption coefficient was calculated from a transmittance at each wavelength of 248, 193 and 157 nm and the coating film thickness. The results are shown in Table 1.

### COMPARATIVE EXAMPLE 5

(1) Preparation of coating composition, (2) coating and (3) measurement of transparency in a vacuum ultraviolet region were carried out in the same manner as in Example 1 except that a perfluoro cyclic polymer (Teflon AF1600, trade name of Du Pont) was used as a fluorine-containing polymer and HCFC-225 was used as a solvent. Calculated molecular absorption coefficient is shown in Table 1.

TABLE 1

| | Fluorine- | Absorption | Absorption | Absorption |
|---|---|---|---|---|
| | containing polymer | coefficient | coefficient | coefficient |
| | (A) | at 248 nm (μm⁻¹) | at 193 nm (μm⁻¹) | at 157 nm (μm⁻¹) |
| Ex. 1 | Prep. Ex. 1 | 0.01 or less | 0.01 or less | 0.17 |
| Ex. 2 | Prep. Ex. 2 | 0.01 or less | 0.01 or less | 0.22 |
| Ex. 3 | Prep. Ex. 3 | 0.01 or less | 0.01 or less | 0.19 |
| Ex. 4 | Prep. Ex. 4 | 0.01 or less | 0.01 or less | 0.19 |
| Ex. 5 | Prep. Ex. 5 | 0.01 or less | 0.01 or less | 0.10 |
| Ex. 6 | Prep. Ex. 6 | 0.01 or less | 0.01 or less | 0.12 |
| Ex. 7 | Prep. Ex. 7 | 0.01 or less | 0.01 or less | 0.3 |
| Ex. 8 | Prep. Ex. 9 | 0.01 or less | 0.01 or less | 0.49 |
| Com. Ex. 1 | Prep. Ex. 8 | 0.01 or less | 0.66 | 4.4 |
| Com. Ex. 2 | Prep. Ex. 10 | 0.01 or less | 0.2 | 3.1 |
| Com. Ex. 3 | Prep. Ex. 11 | 0.01 or less | 0.01 or less | 1.2 |
| Com. Ex. 4 | Prep. Ex. 12 | 0.01 or less | 0.01 or less | 1.33 |
| Com. Ex. 5 | — | 0.01 or less | 0.01 or less | 0.7 |

The pellicle film of the present invention is excellent in transmittance of vacuum ultraviolet light, particularly F₂ laser light (157 nm), and lowering of transmittance and a decrease in a film thickness due to photo-degrading are inhibited. Thereby excellent laser exposure resistance and transmittance can be maintained for a long period of time and a clear pattern can be produced.

What is claimed is:

1. A pellicle film for lithography comprising a solvent-soluble fluorine-containing polymer (A), in which the polymer (A) is non-crystalline and is composed of a chain structure having no ring structure on its trunk chain, an absorption coefficient at 157 nm of said polymer (A) being not more than 0.5 μm⁻¹.

2. The pellicle film for lithography of claim 1, wherein the fluorine-containing polymer (A) has a Rf group on its side chain, said Rf group is a fluoroalkyl group of a linear or branched chain of C4 to C 100 in which at least a part of hydrogen atoms is replaced with fluorine atoms and/or an ether-bond-containing fluoroalkyl group of a linear or branched chain of C4 to C 100 in which at least a part of hydrogen atoms is replaced with fluorine atoms.

3. The pellicle film for lithography of claim 2, wherein said Rf group is a perfluoroalkyl group of a linear or branched chain of C4 to C100 and/or an ether-bond-containing perfluoroalkyl group of a linear or branched chain of C4 to C100.

4. The pellicle film for lithography of claim 2, wherein the fluorine-containing polymer (A) is a fluorine-containing polymer represented by the formula (1):
−(M)−(A)− (1)
in which the structural unit M is a structural unit represented by the formula (M1): 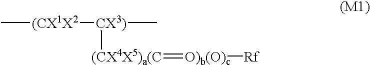
wherein X¹ and X² are the same or different and each is H or F; X³ is H, F, CH₃ or CF₃; X⁴ and X⁵ are the same or different and each is H, F or CF₃; a, b and c are the same or different and each is 0 or 1; when a is 0, Rf is at least one selected from a fluoroalkyl group of a linear or branched chain of C4 to C 100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms; when a is 1, Rf is at least one selected from a fluoroalkyl group of a linear or branched chain of C3 to C99 in which at least a part of hydrogen atoms is replaced with fluorine atoms or an ether-bond-containing fluoroalkyl group of a linear or branched chain of C3 to C99 in which at least a part of hydrogen atoms is replaced with fluorine atoms,
the structural unit A is a structural unit derived from a monomer copolymerizable with the fluorine-containing ethylenic monomer giving the structural unit M represented by the formula (M1),
said polymer comprises from 1 to 100% by mole of the structural unit M and from 0 to 99% by mole of the structural unit A.

5. The pellicle film for lithography of claim 4, wherein in the formula (1), the structural unit M is a structural unit represented by the formula (M2): 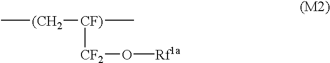
wherein Rf^{1a} is at least one selected from a fluoroalkyl group of a linear or branched chain of C3 to C99 in which at least a part of hydrogen atoms is replaced with fluorine atoms or an ether-bond-containing fluoroalkyl group of a linear or branched chain of C3 to C99 in which at least a part of hydrogen atoms is replaced with fluorine atoms.

6. The pellicle film for lithography of claim 4, wherein in the formula (1), the structural unit M is a structural unit represented by the formula (M3): 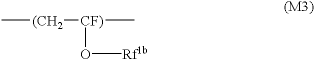
wherein Rf^{1b} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

7. The pellicle film for lithography of claim 5, wherein in the formulae (M2), Rf^{1a} is at least one selected from a perfluoroalkyl group of a linear or branched chain or an ether-bond-containing perfluoroalkyl group of a linear or branched chain.

8. The pellicle film for lithography of claim 6, wherein in the formulae (M3), Rf^{1b} is at least one selected from a perfluoroalkyl group of a linear or branched chain or an ether-bond-containing perfluoroalkyl group of a linear or branched chain.

9. The pellicle film for lithography of claim 4, wherein in the formula (1), the structural unit M is a structural unit represented by the formula (M4): 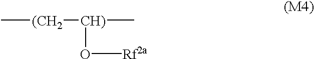
wherein Rf^{2a} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

10. The pellicle film for lithography of claim 4, wherein in the formula (1), the structural unit M is a structural unit represented by the formula (M5): 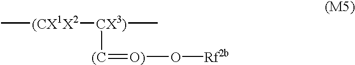
wherein X¹ and X² are the same or different and each is H or F; X³ is H, F, CH₃ or CF₃; Rf^{2b} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

11. The pellicle film for lithography of claim 4, wherein in the formula (1), the structural unit M is a structural unit represented by the formula (M6): 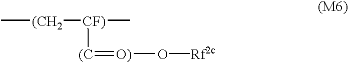
wherein Rf^{2c} is at least one selected from a fluoroalkyl group of a linear or branched chain of C4 to C100 in which at least a part of hydrogen atoms is replaced with fluorine atoms or an ether-bond-containing fluoroalkyl group of a linear or branched chain of C4 to C100 in which at least a part of hydrogen atoms is replaced with fluorine atoms.

12. The pellicle film for lithography of claim 9, wherein in the formula (M4), Rf^{2a} is: 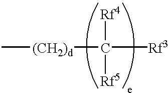
wherein Rf³ is at least one selected from a fluoroalkyl group of a linear or branched chain in which at least a part of hydrogen atoms is replaced with fluorine atoms or an ether-bond-containing fluoroalkyl group of a linear or branched chain in which at least a part of hydrogen atoms is replaced with fluorine atoms; Rf⁴ and Rf⁵ are the same or different and each is at least one selected from hydrogen atom, a perfluoroalkyl group having 1 to 5 carbon atoms or a hydrocarbon group having 1 to 10 carbon atoms; a sum of carbon atoms of Rf³, Rf⁴ and Rf⁵ is from 4 to 100; d is 0 or 1; e is 0 or an integer of 1 or 2; provided that d is 0, e is 1 or 2.

13. The pellicle film for lithography of claim 10, wherein in the formula (M5), Rf^{2b} is: 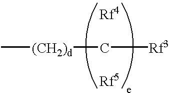
wherein Rf³ is at least one selected from a fluoroalkyl group of a linear or branched chain in which at least a part of hydrogen atoms is replaced with fluorine atoms or an ether-bond-containing fluoroalkyl group of a linear or branched chain in which at least a part of hydrogen atoms is replaced with fluorine atoms; Rf⁴ and Rf⁵ are the same or different and each is at least one selected from hydrogen atom, a perfluoroalkyl group having 1 to 5 carbon atoms or a hydrocarbon group having 1 to 10 carbon atoms; a sum of carbon atoms of Rf³, Rf⁴ and Rf⁵ is from 4 to 100; d is 0 or 1; e is 0 or an integer of 1 or 2; provided that d is 0, e is 1 or 2.

14. The pellicle film for lithography of claim 11, wherein in the formula (M6), Rf^{2c} is: 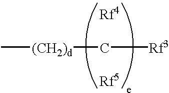
wherein Rf³ is at least one selected from a fluoroalkyl group of a linear or branched chain in which at least a part of hydrogen atoms is replaced with fluorine atoms or an ether-bond-containing fluoroalkyl group of a linear or branched chain in which at least a part of hydrogen atoms is replaced with fluorine atoms; Rf⁴ and Rf⁵ are the same or different and each is at least one selected from hydrogen atom, a perfluoroalkyl group having 1 to 5 carbon atoms or a hydrocarbon group having 1 to 10 carbon atoms; a sum of carbon atoms of Rf³, Rf⁴ and Rf⁵ is from 4 to 100; d is 0 or 1; e is 0 or an integer of 1 or 2; provided that d is 0, e is 1 or 2.

15. The pellicle film for lithography of claim 12, wherein, Rf³ is at least one selected from a perfluoroalkyl group of a linear or branched chain or an ether-bond-containing perfluoroalkyl group of a linear or branched chain.

16. The pellicle film for lithography of claim 13, wherein, Rf³ is at least one selected from a perfluoroalkyl group of a linear or branched chain or an ether-bond-containing perfluoroalkyl group of a linear or branched chain.

17. The pellicle film for lithography of claim 14, wherein, Rf³ is at least one selected from a perfluoroalkyl group of a linear or branched chain or an ether-bond-containing perfluoroalkyl group of a linear or branched chain.

18. The pellicle film for lithography of claim 1, wherein an absorption coefficient at 157 nm of the fluorine-containing polymer (A) is not more than 0.3 μm⁻¹.

19. The pellicle film for lithography of claim 4, wherein an absorption coefficient at 157 nm of the fluorine-containing polymer (A) is not more than 0.3 μm⁻¹.

20. The pellicle film for lithography of claim 1, which is used for a photolithography process using a F₂ laser.

21. The pellicle film for lithography of claim 4, which is used for a photolithography process using a F₂ laser.
